(19) United States
(12) Patent Application Publication
(10) Pub. No.: US 2010/0045160 A1
(43) Pub. Date: Feb. 25, 2010

(54) MULTIBEAM DOUBLY CONVERGENT ELECTRON GUN

(75) Inventors: James A. Dayton, JR., Cleveland, OH (US); Carol L. Kory, Westlake, OH (US)

Correspondence Address: FAY SHARPE LLP, 1228 Euclid Avenue, 5th Floor, The Halle Building, Cleveland, OH, 44115, US

(73) Assignee: Manhattan Technologies Ltd.

(21) Appl. No.: 12/544,378

(22) Filed: Aug. 20, 2009

Related U.S. Application Data
(60) Provisional application No. 61/090,285, filed on Aug. 20, 2008.

(51) Int. Cl. H01J 29/51

(52) U.S. Cl. 313/414

(57) ABSTRACT

This disclosure describes a multibeam doubly convergent electron gun. Two or more beamlets can be run parallel to the axis at a prescribed radius to produce sufficient current to drive the VED. In order to obtain sufficient cathode surface area to provide the required current, the beamlets are launched from a cathode radius greater than the radius required in a slow wave circuit. In one embodiment, an electron gun includes a focus electrode that surrounds two or more cathodes, wherein each cathode emits a beamlet comprised of a plurality of electrons directed to a predetermined location. A first anode receives each beamlet at the predetermined location, accelerates each beamlet and changes the radius of each beamlet. A second anode receives each beamlet from the first anode, directs each beamlet along a predetermined axis, further accelerates, and can further compress each beamlet.

### PRIORITY

This application claims the priority of provisional application 61/090,285, filed Aug. 20, 2008.

### RIGHTS IN INVENTION

This project was funded in part by U.S. Government contracts FA9550-07-C-0076 and W911NF-06-C-0086. Therefore, the United States government may own certain rights to this invention.

### BACKGROUND

The present exemplary embodiment relates to microwave, millimeter and sub millimeter wavelength generation, amplification and processing arts. It finds particular application in conjunction with electron devices, and will be described with particular reference thereto. It is to be appreciated, however, that the present exemplary embodiment is also amenable to other like applications.

Vacuum electron devices, such as a traveling wave tube (TWT), a klystron, and a backward wave oscillator (BWO), are commonly used as amplifiers of electromagnetic signals or as sources of electromagnetic energy for applications that require operation at high frequency or high power. Both the TWT and the BWO operate on the same principle, that the kinetic energy of an electron beam can be converted into electromagnetic energy by passing an electron beam through an interaction region known as a slow wave circuit.

The most common form of a slow wave circuit is simply a helical coil of wire. In the slow wave circuit, the axial propagation of an electromagnetic wave is slowed so that it is moving in approximate synchronism with the electron beam. In the case of a helix, the electromagnetic wave follows the path of the wire so that its axial progress is determined by the pitch of the helix. In the TWT, the electromagnetic wave propagates on the slow wave circuit in the same direction as the electron beam in a mode that amplifies the electromagnetic wave. In the mode of operation of the BWO, an electromagnetic oscillation is produced that actually propagates in the opposite direction to the electron beam, hence its name, backward wave.

The electron beam is formed by an electron gun that typically consists of a source of electrons, such as a thermionic cathode, an electrode nearby the cathode that focuses the beam, and one or more anodes that accelerate the beam. A thermionic cathode emits electrons when it is heated to a high temperature. The resulting electron emission current at the cathode is sometimes too low to successfully operate the VED. Therefore, in some applications, it is necessary to have multiple electron beams to achieve the required total current. At low frequency, the size of the circuit is relatively large, and thus it may be feasible to emit the beams from the cathode at the same central radii that they will occupy within the slow wave circuit. For higher frequency operation, however, this is not satisfactory because the beams must pass through a slow wave circuit that is greatly reduced in size. Accordingly, what are needed are systems and methods to accommodate the small dimensions of the slow wave circuit for proper operation of an electron gun.

### BRIEF DESCRIPTION

In one aspect, an electron gun includes a focus electrode that surrounds two or more cathodes, wherein each cathode emits a beamlet comprised of a plurality of electrons directed to a predetermined location. A first anode receives each beamlet at the predetermined location, accelerates each beamlet and reduces the radius of each beamlet. A second anode receives each beamlet from the first anode, directs each beamlet along a predetermined axis, further accelerates each beamlet, and possibly changes the radius of each beamlet.

In another aspect, an electron gun includes two or more cathodes that each emits a beamlet, the beamlets are divided into a first cluster and a second cluster. A first anode receives the first cluster and the second cluster of beamlets via a first opening and a second opening, accelerates each beamlet and reduces the radius of each beamlet. A second anode receives the beamlets from the first anode, directs each beamlet along a predetermined axis, further accelerates each beamlet, and possibly changes the radius of each beamlet.

In yet another aspect, an electron gun includes at least two cathodes that each emits a beamlet toward a predetermined location. An anode receives the beamlets emitted by the cathode, accelerates each beamlet, reduces the radius of each beamlet and directs each beamlet along a predetermined axis.

### BRIEF DESCRIPTION OF THE DRAWINGS

FIGS. 1A, 1B and 1C illustrate an eight beam doubly convergent thermionic electron gun, in accordance with an exemplary embodiment.

FIGS. 2A and 2B illustrate a focus electrode and eight cathodes of the electron gun in FIG. 1, in accordance with an exemplary embodiment.

FIGS. 3A, 3B and 3C illustrate a first anode utilized with the electron gun of FIG. 1, in accordance with an exemplary embodiment.

FIGS. 4A and 4B illustrate an alternative first anode utilized with the electron gun of FIG. 1, in accordance with an exemplary embodiment.

FIGS. 5A and 5B illustrate a second anode utilized with the electron gun of FIG. 1, in accordance with an exemplary embodiment.

FIG. 6 illustrates a detail of a second anode aperture, in accordance with an exemplary embodiment.

FIG. 7 illustrates the beamlets as they travel through the electron gun of FIG. 1, in accordance with an exemplary embodiment.

FIG. 8 illustrates the beamlets as they travel from the first anode and exit the second anode, in accordance with an exemplary embodiment.

FIG. 9 illustrates a side profile of the electrostatic potentials within the electron gun, in accordance with an exemplary embodiment.

FIG. 10 illustrates the beamlets propagating through the alternate first anode, in accordance with an exemplary embodiment.

FIG. 11 illustrates the beamlets as they exit the second anode utilizing the alternate first anode, in accordance with an exemplary embodiment.

FIG. 12 illustrates a side profile of the electron gun electrostatic potentials utilizing the alternate first anode, in accordance with an exemplary embodiment.

FIG. 13 illustrates a dual beam doubly convergent thermionic electron gun with two anodes, in accordance with an exemplary embodiment.

FIGS. 14A and 14B illustrate the focus electrode and cathodes of the electron gun of FIG. 13, in accordance with an exemplary embodiment.

FIGS. 15A, 15B, 15C and 15D illustrate a first anode of the electron gun of FIG. 13, in accordance with an exemplary embodiment.

FIGS. 16A, 16B and 16C illustrate a second anode of the electron gun of FIG. 13, in accordance with an exemplary embodiment.

FIG. 17 illustrates a detail of an aperture of the second anode of FIG. 16, in accordance with an exemplary embodiment.

FIG. 18 illustrates the trajectories of the beamlets as they travel through the electron gun, in accordance with an exemplary embodiment.

FIG. 19 illustrates a dual beam doubly convergent thermionic electron gun with a single anode, in accordance with an exemplary embodiment.

FIGS. 20A and 20B illustrate a cathode and focus electrode of the electron gun of FIG. 19, in accordance with an exemplary embodiment.

FIGS. 21A and 21B illustrate a detail of the cathode and focus electrode of the electron gun of FIG. 19, in accordance with an exemplary embodiment.

FIGS. 22A and 22B illustrate an anode of the electron gun of FIG. 20, in accordance with an exemplary embodiment.

FIGS. 23A and 23B illustrate a detail of an aperture of the anode, in accordance with an exemplary embodiment.

FIG. 24 illustrates the trajectories of the beamlets as they travel through the electron gun of FIG. 19, in accordance with an exemplary embodiment.

### DETAILED DESCRIPTION

The operation of a typical vacuum electron device (VED) requires an electron beam to pass through an interaction region such as a slow wave circuit in order to produce the desired amplification or oscillation. Generally, the current density required is greater than what is practical to achieve with a thermionic cathode. To achieve a suitable current for operation of the VED, an electron gun is used to compress the beam of electrons emitted from the cathode to operate the VED. In some instances, for operation at lower frequency, the current carried by a single electron beam is not sufficient to operate the VED at the desired beam voltage. In these instances, it may be possible to use an array of singly convergent electron beams to achieve the desired current. The electron gun design problem is further exacerbated for operation at higher frequencies where the dimensions of the interaction region are greatly reduced, corresponding to the shorter wavelengths, and the electron beam must be converged a second time to pass through a smaller space.

Although modern microfabrication technology can be applied to achieve the greatly reduced VED dimensions required for operation at millimeter and sub millimeter wavelengths, there is no comparable technology to reduce the diameter of the electron beam. The maximum practical electron beam current density is limited by the strength of the available magnetic focusing field. The required operating current may only be achievable by using multiple electron beams. Because of the reduced dimensions for millimeter and sub millimeter wavelength operation, however, these multiple beams must be compressed twice. Once to achieve higher current density and a second time to pass through the smaller space available in the interaction region.

Three embodiments of this concept are discussed herein to provide dual compression: 1) a dual anode approach in which a plurality of electron beams are arranged in a circular array; 2) a dual anode, dual beam configuration; and 3) a single anode, dual beam approach. All of these guns are designed to operate with helical slow wave circuits that are so small that it is not possible to pass significant beam current through the helix center as is done conventionally. Instead, multiple electron beams are formed by the doubly convergent electron guns. These pass above and below the helix in the relatively larger space outside of the helix. In each case, the beam convergence is accomplished electrostatically. The beam transmission through the slow wave circuit is controlled by a strong axial magnetic field, which is excluded from the electron gun.

Multibeam Electron Gun

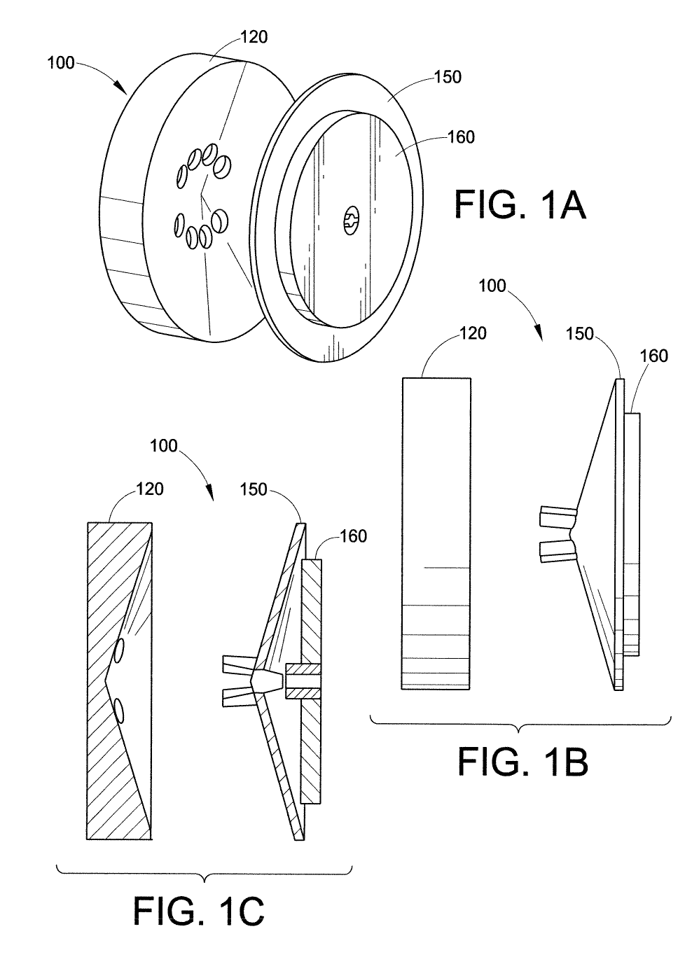

FIGS. 1A, 1B and 1C illustrate an isometric, side and cross-sectional view of a multibeam thermionic electron gun 100 that converges and directs a plurality of beamlets along predetermined axes. The convergence of these beamlets provides a higher current than what is generated using a single beam emission. In one embodiment, the predetermined axes are parallel to the centerline of a vacuum electron device (VED) (not pictured). The VED can be a traveling-wave tube (TWT) that contains a helical slow wave circuit that is disposed axisymmetrically to the TWT. The convergent beams are created via a two stage design to accommodate the dimensions of the VED. A first stage accelerates and compresses each beamlet to a smaller central radius. A second stage further accelerates each beamlet, steers the beamlets along the predetermined axes, and can also further vary the radius of the beamlets. The use of two stages to converge the beamlets makes the electron gun 100 doubly convergent.

The electron gun 100 contains a focus electrode 120, which holds a plurality of cathodes 132, 134, 136, 138, 140, 142, 144, 146 that each emits a beamlet. A first anode 150 and a second anode 160 are employed to accelerate the electrons within each beamiet emitted from the cathodes 132-146. The first anode 150 and the second anode 160 are each aligned with the focus electrode 120 along a common axis. In one embodiment, the common axis is the axial centerline of the VED. The diameter of the focus electrode 120 is around 2 mm, in one example.

The cathodes 132-146 are disposed in a generally circular pattern and oriented toward a predetermined location for convergence. In one example, the convergence location is the second anode 160, which is located adjacent to the axial centerline (major axis) of the VED. In this exemplary embodiment, the number of cathodes within the focus electrode 120 is even, wherein the cathodes are divided into a first cluster 170 and a second cluster 180. The first cluster 170 includes the cathodes 132, 134, 136, 138 and the second cluster 180 includes the cathodes 140, 142, 144, 146.

The cathodes 132-138 within the first cluster 170 can converge on a first location above the major axis whereas the cathodes 140-146 within the second cluster 180 can converge on a second location below the major axis. In this manner, beamlets can maintain a closer proximity to other beamlets within the same cluster as they progress through the electron gun 100 and are emitted into a VED. The focus electrode 120 can have a concave shape on the front side (side of beamlet emission) to provide suitable orientation for each cathode 132-146. The rear side (side opposite beamlet emission) of the first anode 150 can have a convex shape to match the front side of the focus electrode 120.

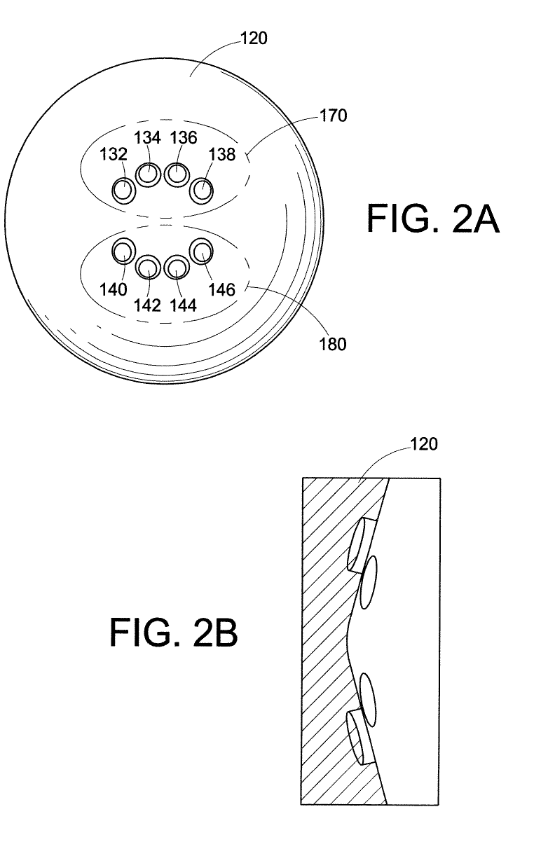

The location and orientation of each cathode 132-146 can be dependent on any number of factors such as distance from a convergence point, geometry of arrangement, power requirements, potential values of each structure and/or location within the gun 100, etc. It is to be appreciated that any suitable arrangement and/or number of cathodes with substantially any shape can be employed. In one example, as illustrated in FIGS. 2A and 2B, the distance from the center point of the cathodes to the major axis of the focus electrode 120 is 500-700 microns. The diameter of each cathode can be 200-250 microns with an angle of 15-20 degrees relative to the major axis to allow convergence to the predetermined location for each beamlet. The current of the converged beamlets emitted from the second anode 160 is equal to the sum of the current of each beamlet. In one example, the converged beamlets have a current of around 32 mA, wherein each of eight beamlets has a current of around 4 mA.

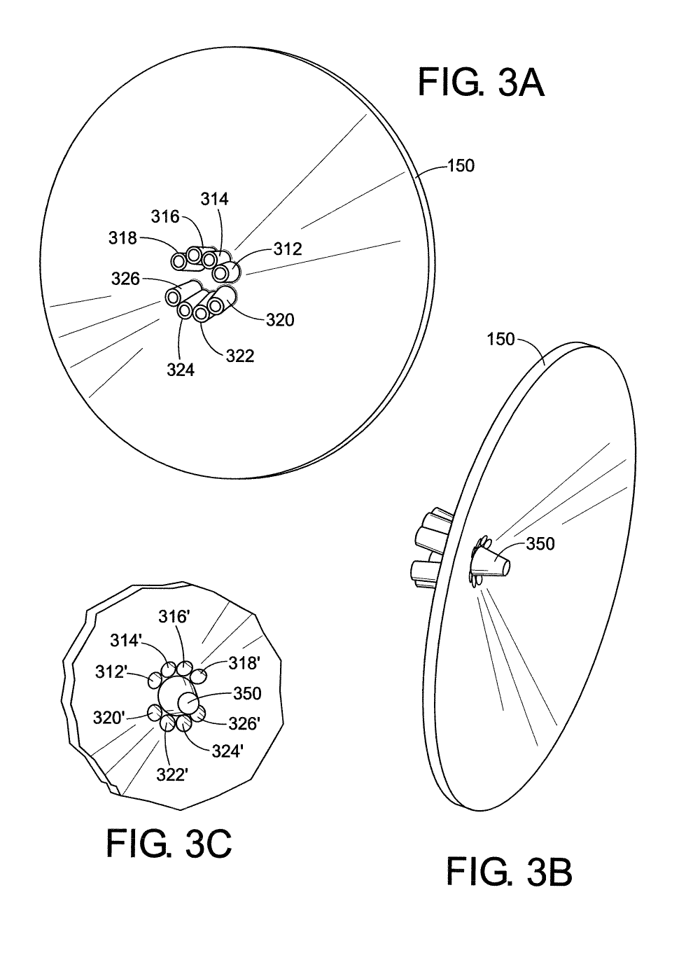

The beamlets emitted from the cathodes 132-146 are first directed to the first anode 150, wherein each beamlet is accelerated and compressed as it travels between the respective cathode 132-146 to the first anode 150. As depicted in FIGS. 3A, 3B and 3C, the front side of the first anode 150 can include a plurality of barrels 312, 314, 316, 318, 320, 322, 324 and 326 that each receives a beamlet from the cathode 132-146 to direct it to the second anode 160. The angle, location and diameter of each barrel 312-326 can be commensurate with the angle, location and diameter of the beamlet associated therewith. In one embodiment, the inner diameter of each barrel aperture can be 90-120 microns and oriented 15-20 degrees relative to the major axis of the VED to match the angle of the cathodes 132-146.

The rear side of the first anode 150 includes apertures 312′, 314′, 316′, 318′, 320′, 322′, 324′ and 326′ associated with the barrels 312-326 respectively. A conical structure 350 protrudes from the center of the rear of the first anode 150. The conical structure 350 can interact with the second anode 160 to create an electrostatic prism to direct the beamlets along a predetermined axis. Beamlets emitted from the cathodes 132-146 enter the barrels 312-316 and exit the first anode 150 via the apertures 312′-326′. The electrostatic prism can modify the direction of travel for the electrons within each beamlet based on the potential value of each structure within the electron gun 100, the distance between the first anode 150 and the second anode 160, and/or the size and location of structures related to the first anode 150 and the second anode 160.

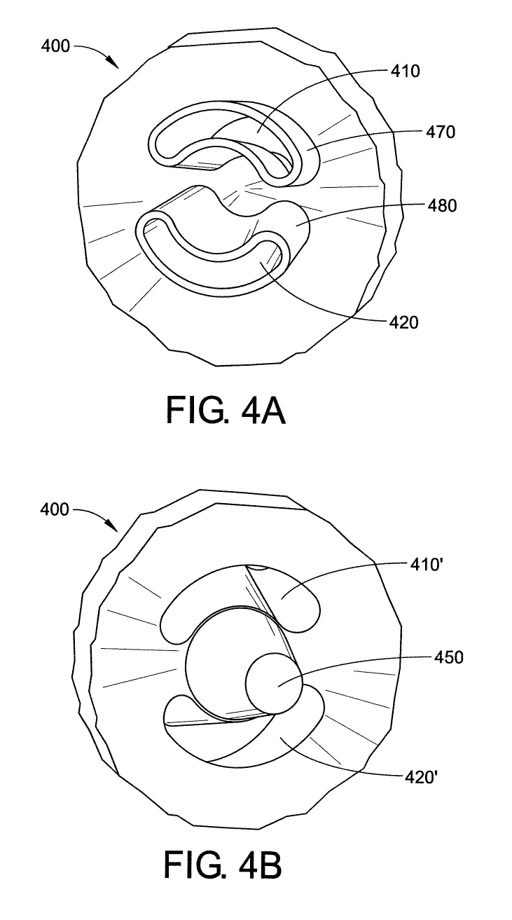

FIGS. 4A and 4B illustrate a first anode 400, which is an alternate design of the first anode 150 depicted in FIG. 3 above. In this embodiment, a first aperture 410 and a second aperture 420 are used in place of the barrels 312-326 to receive and direct beamlets from the cathodes 132-146. The apertures are formed to accommodate the location and orientation of the cathodes 132-146, such as a kidney shape in this example. A wall 470 and a wall 480 each surround the apertures on the front side to direct a plurality of beamlets through the apertures 410 and 420. The walls 470, 480 can follow the outline of each aperture 410, 420. The rear side of the first anode 400 includes the apertures 410, 420 and a conical structure 450 that is employed to direct the beamlets and to contribute to creation of an electrostatic field between the first anode 400 and the second anode 160, as discussed above with reference to the first anode 150.

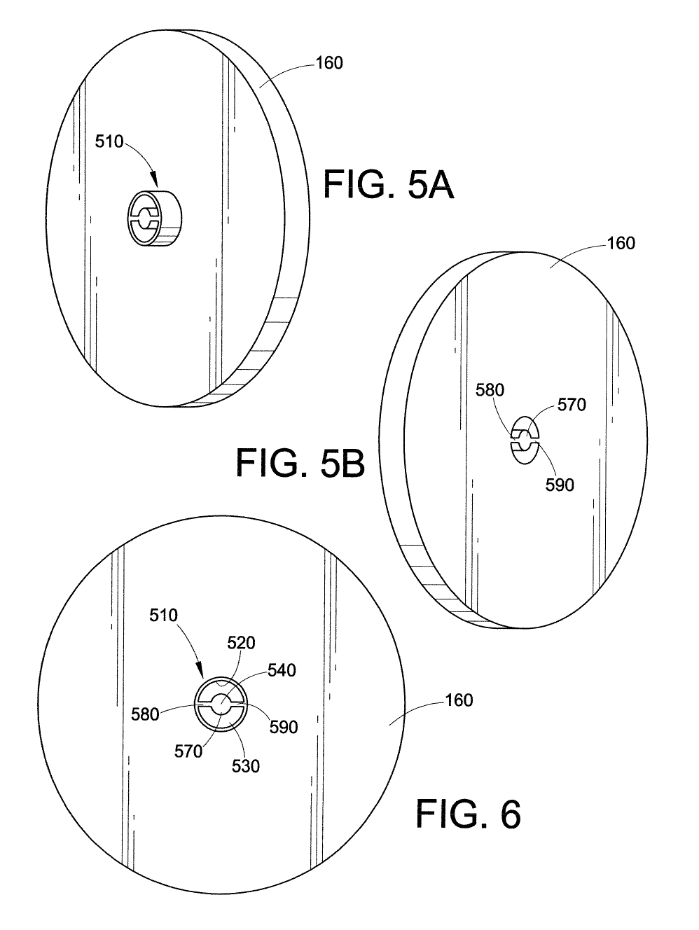

FIGS. 5A and 5B depict the front side and the back side, respectively, of the second anode 160, which is circular in shape in this embodiment. The second anode 160 can be positioned along the axial centerline of the focus electrode 120, and the first anode (150, 400). As beamlets exit the second anode 160, their shape, size and location can be controlled via a magnetic field throughout a VED. In one example, the second anode 160 serves as a first magnetic pole piece to facilitate generation of the magnetic field within the VED.

In this example, a raised structure 510 is circular and disposed in the center of the second anode 160. The structure 510 includes a first opening 520 and a second opening 530 separated by a cross member 540. As shown in FIG. 5B, the openings 520 and 530 extend completely through the second anode 160 from the front side to the back side. As illustrated in FIG. 6, the first opening 520 and the second opening 530 can be generally equal in size with an arched shape that extends nearly 180 degrees on the top and bottom of the cross member 540. The cross member 540 has a center circular component 570 with arms 580 and 590 generally equal in size extending equidistant therefrom on opposite sides. The width of each opening 510,520 is about 100 microns with an outer radius of around 150-200 microns. It is to be appreciated, however, that the size and location of the first opening 520 and the second opening 530 can vary proportionate to size of the beamlets, number of beamlets, potentials within the electron gun 100, etc.

In this example, the size of the first opening 520 and the second opening 530 are the same on the front side and the back side of the second anode 160. Beamlets 132-138 within the cluster 170 can enter the first opening 520 and beamlets 140-146 within the second cluster 180 can enter second opening 530. Beamlets 132-146 enter the structure 510 at a particular angle of incidence from the first anode 150,400 on the front side of the second anode 160. In one example, the angle of incidence of each beamlet 132-146 (e.g., 15-20 degrees) is generally equal relative to the axial centerline. As the beamlets 132-146 travel through the structure 510, they are redirected from the angle of incidence to an alternate axis of travel. In one example, the beamlets are generally parallel to each other and to the major axis of the VED upon exit from the structure 510 on the back side of the second anode 160. As each beamlet exits the second anode 160, it can have a radius of around 40 microns and is located at a radius of about 130 microns from the major axis of the VED.

The potential of the first anode 150 is greater than the potential of the focus electrode 120 to facilitate beamlet acceleration and compression. In one embodiment, the potential of the focus electrode 120 is around 0 V and the potential of the first anode 150 is 2-5 kV. To further increase acceleration, the second anode 160 can have a potential greater than the first anode 150,400, such as 6-8 kV for example. In this manner, the potential of the beamlets increase as they are drawn from the cathode 120, to the first anode 150,400 and on to the second anode 160, commensurate with the respective potential of these structures. Moreover, the radius of each beamlet can be altered as they pass from the focus electrode 120 to the first anode 150 and again from the first anode 150 to the second anode 160.

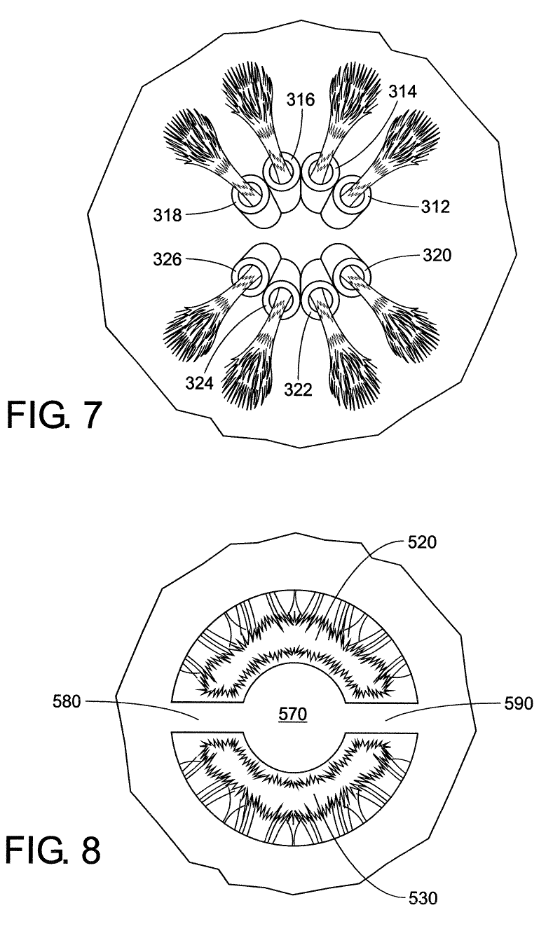

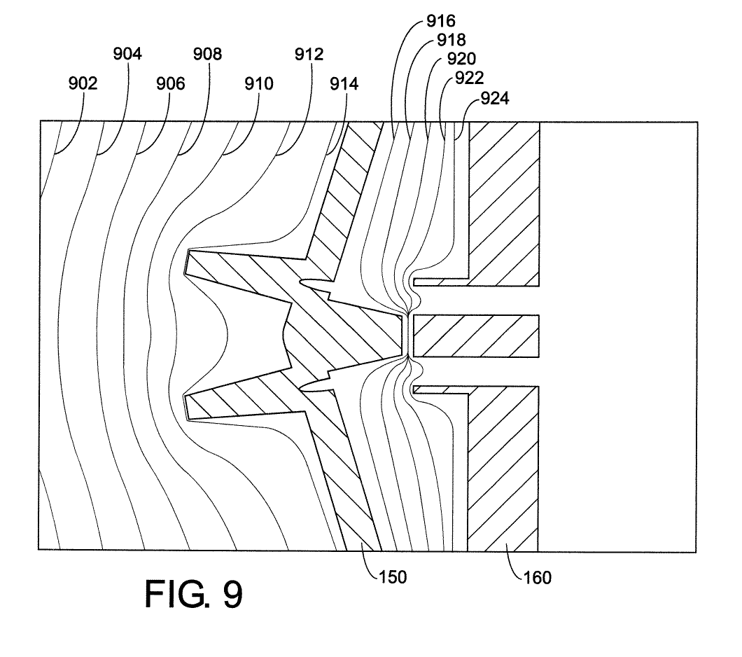

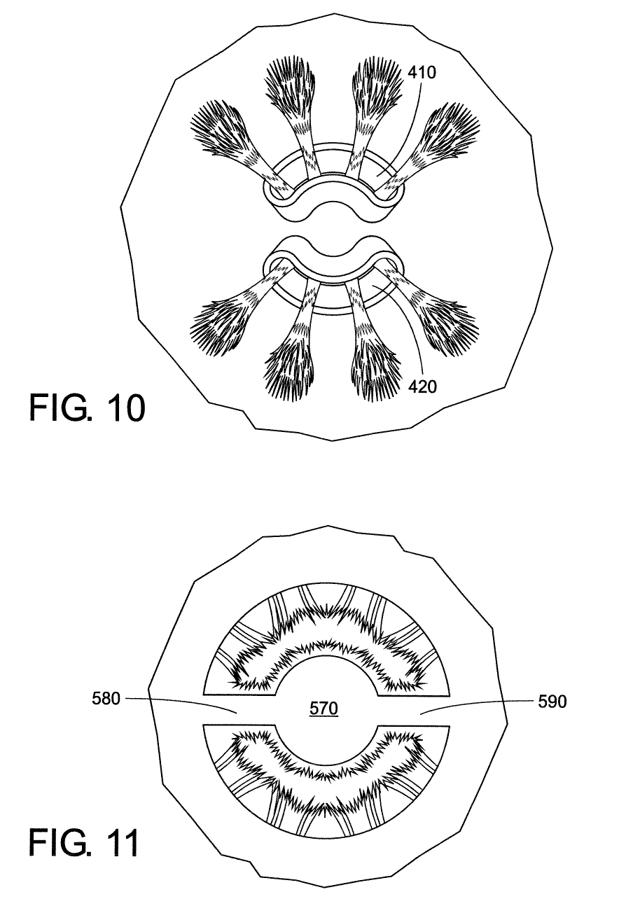

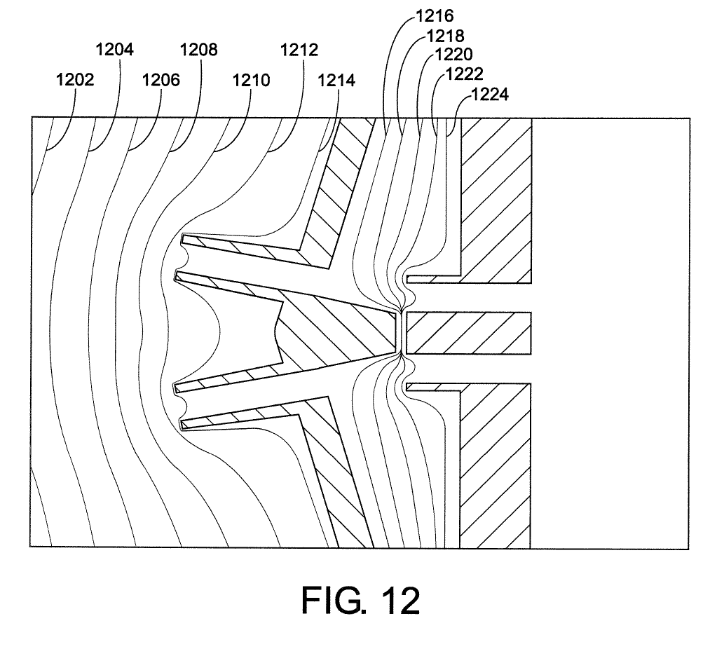

FIGS. 7 and 10 are axial views of the beamlets as they travel from the cathode 120 to the first anode 150 and the first anode 400, respectively. FIGS. 8 and 11 illustrate an axial view of the beamlets exiting from the second anode 160 received from the first anode 150 and the first anode 400 respectively. FIG. 9 shows equipotential lines 902, 904, 906, 908, 910, 912, 914, 916, 918, 920, 922, and 924 within the electron gun that includes the first anode 150 and the second anode 160. Similarly, FIG. 12 illustrates equipotential lines 1202, 1204, 1206, 1208, 1210, 1212, 1214, 1216, 1218, 1220, 1222, and 1224 within the electron gun that includes the first anode 400 and the second anode 160. The size and shape of each field in FIGS. 9 and 12 are exemplary and can vary commensurate to the size and shape of structures and associated potential values within the electron gun.

Dual Beam Doubly Convergent—Dual Anode Gun

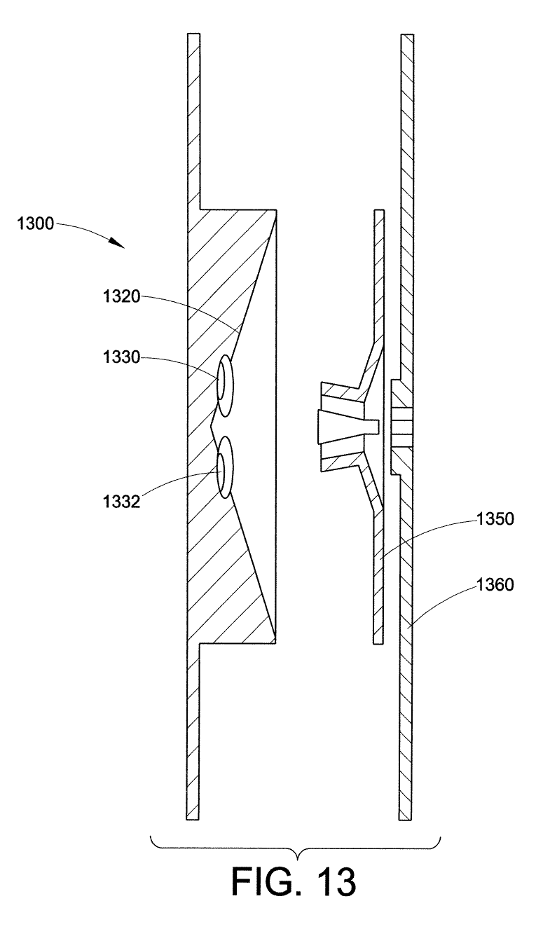

FIG. 13 illustrates a dual beam doubly convergent electron gun 1300 that is an alternate form of the multibeam electron gun 100. In this embodiment, the circular array of cathodes 132-146 are replaced with a first cathode 1330 and a second cathode 1332 that emit a pair of kidney shaped beamlets. The first cathode 1330 and the second cathode 1332 are mounted in the focus electrode 1320 with a dihedral angle that directs the beam toward a predetermined axis. The cathodes 1330, 1332 emit beamlets that are received by a first anode 1350 and a second anode 1360. The beamlets are emitted from the second anode 1360 in parallel with one another, in one example, and are adjacent to a major axis (e.g., axial centerline) of a VED (not pictured) coupled to the electron gun 1300.

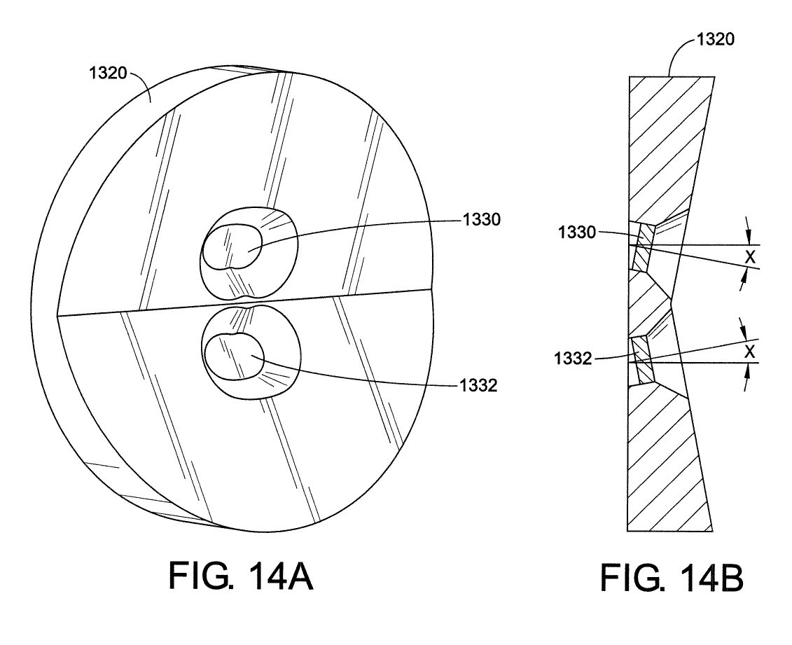

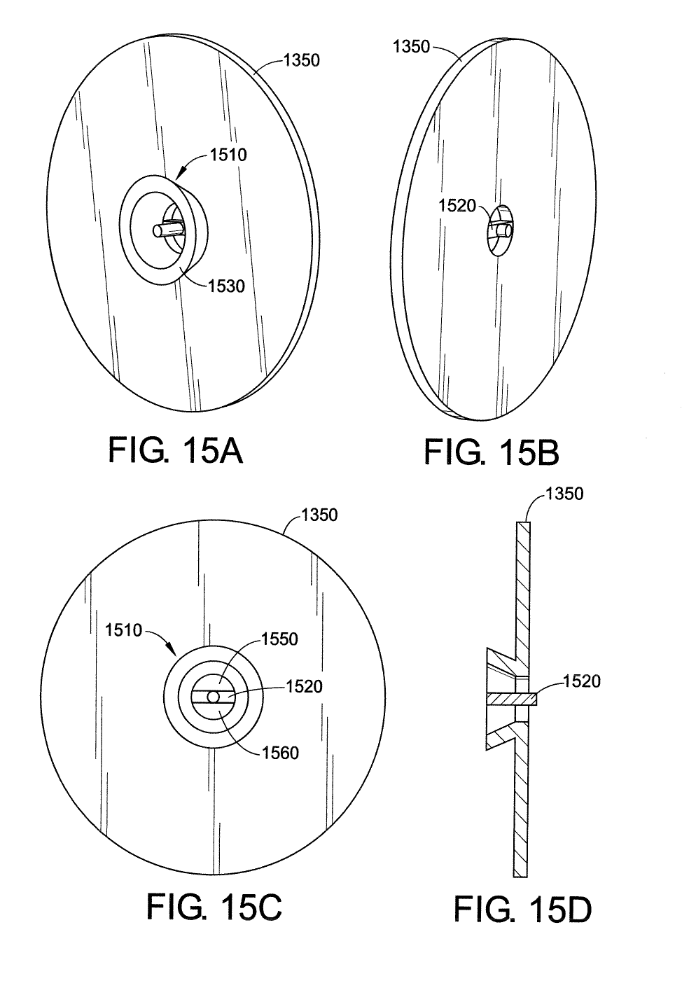

The beamlets emitted from the cathodes 1330, 1332 are compressed between the cathode 1330, 1332 and the first anode 1350. An electric field created between the first anode 1350 and the second anode 1360 creates an electrostatic prism that directs the beamlets into a path parallel to the major axis. Thus, similar to the operation of the electron gun 100, the electron gun 1300 utilizes a dual stage convergence to first compress beamlets emitted from the cathodes and subsequently directs the compressed beamlets along predetermined axes. FIGS. 14A and 14B illustrate the focus electrode 1320 and the cathodes 1330, 1332 in detail. The radius of the cathodes from the center point of the focus electrode 1320 is 600-700 microns, wherein the dihedral angle X is 15-20 degrees from the major axis, as illustrated in FIG. 15B.

FIGS. 15A, 15B, 15C and 15D illustrate disparate views of the first anode 1350. In particular, FIG. 15A illustrates an isometric front view, FIG. 15B illustrates an isometric back view, FIG. 15C illustrates a two dimensional front view and FIG. 15D illustrates a cross sectional view of the first anode 1350. The beamlets emitted from the cathodes 1330 and 1332 are first directed to the first anode 1350, wherein each beamlet is accelerated and compressed as it travels between the respective cathodes 1330, 1332 to the first anode 1350. The front side of the first anode 1350 can include an element 1510 that receives the beamlets emitted from the cathodes 1330,1332.

The element 1510 includes a central component 1520 and a wall 1530 to guide beamlets received. In one example, both the first anode 1350 and the central component 1520 are circular, wherein the central component 1520 is concentric to the first anode. The central component 1520 includes a post centrally disposed to facilitate guidance of beamlets received, in this exemplary embodiment. A first opening 1550 and a second opening 1560 are defined by the central component 1520 and the wall 1530. The size and location of each opening 1550 and 1560 can be relative to the number, angle and size of beamlets, however, emitted from the focus electrode 1320. The central component 1520 receives beamlets from the cathode 1330, 1332 to direct it to the second anode 1360. The angle, location and diameter of each barrel can be commensurate with the angle, location and diameter of the beamlet associated therewith.

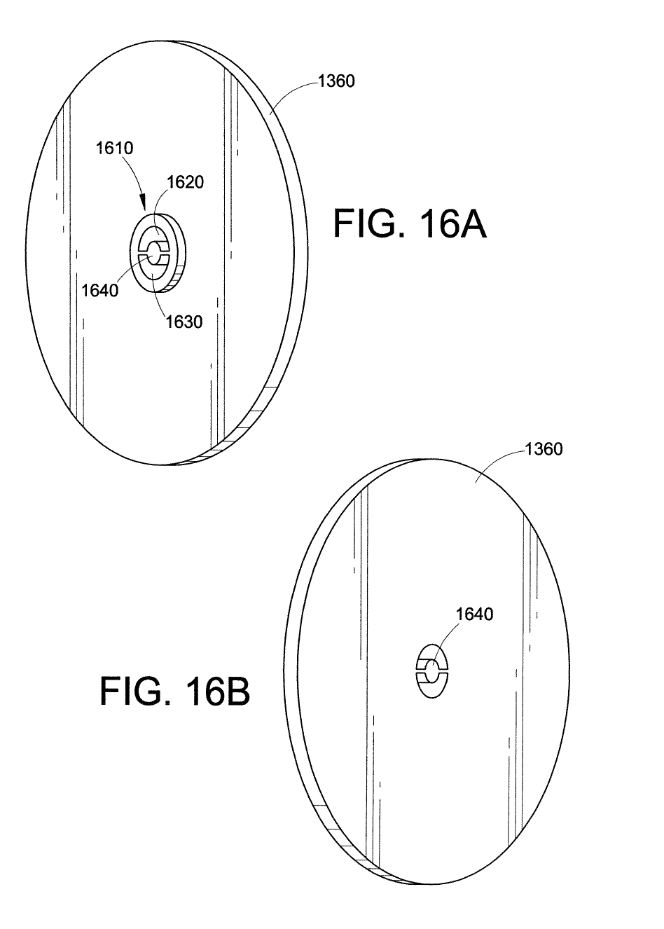

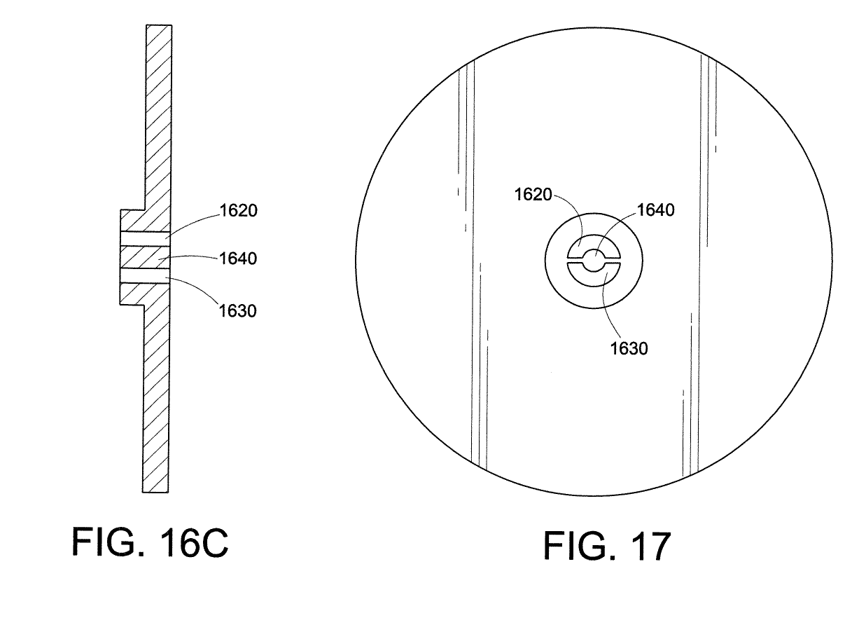

FIGS. 16A, 16B and 16C show an isometric front view, an isometric back view and a side cross-sectional view of the second anode 1360. The two beams emitted from the cathodes 1330 and 1332 are compressed and accelerated by the first anode 1350 shown in FIG. 15. The fields between the first anode 1350 and the second anode 1360 direct the two beams into trajectories that are parallel to a predetermined axis, as discussed above. The diameter of the second anode 1360 can be commensurate with the diameter of the first anode 1350. The second anode 1360 can be positioned along the axial centerline of the focus electrode 1320 and the first anode 1350. In one example, the second anode 1360 serves as a pole piece to facilitate generation of the magnetic field within the VED. In this example, a raised structure 1610 is circular and disposed in the center of the second anode 1360. The structure 1610 includes a first opening 1620 and a second opening 1630 separated by a cross member 1640.

The size and location of the first opening 1620 and the second opening 1630 can vary proportionate to size of the beamlets, number of beamlets, potentials within the electron gun 100, etc. The function and structural features of the second anode 1360 are generally the same as the second anode 160 described in detail above. As discussed with regard to the electron gun 100, an electrostatic prism is created between the first anode 1350 and the second anode 1360 to direct the beamlets along predetermined axes. To create the electrostatic prism, predetermined distances can be utilized to separate the first anode 1350 and the second anode 1360.

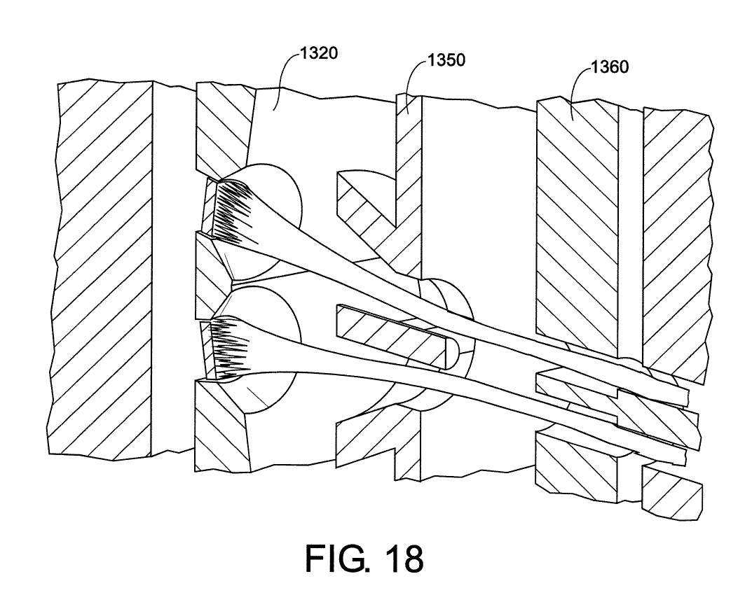

An exemplary detail of the second anode 1360 is set forth in FIG. 17. The second anode 1360 shows the first opening 1620 and the second opening 1630 that are each shaped like an arch to cover a top half and bottom half, respectively, around the major axis. In one example, the cross member 1640 that separates the first opening 1620 and the second opening 1630 is around 1,000 microns in diameter. The radius of each of the first opening 1620 and the second opening 1630 is approximately 200-250 microns. The radius of the first aperture and the second aperture can vary based on the dihedral angle of the focus electrode 1320, first anode 1350, the gap between the first anode 1350 and the second anode 1360, the diameter of each beamlet, etc. FIG. 18 illustrates a simulation of two beamlets drawn from the cathodes 1330, 1332 through the dual beam doubly convergent gun 1300.

Dual Beam Doubly Convergent—Single Anode Gun

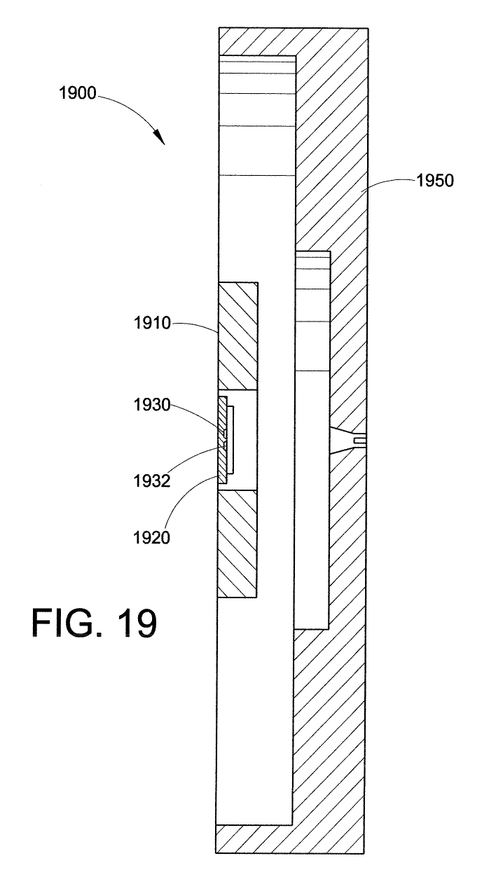

FIG. 19 illustrates an electron gun 1900 that is an alternate embodiment of the electron guns 100 and 1300 described above. The electron gun 1900 includes a shell 1910 and an anode 1950, wherein the shell 1910 surrounds a focus electrode 1920 that contains a first cathode 1930 and a second cathode 1932. The cathodes 1930, 1932 each emit a beamlet. In one example, each cathode 1930, 1932 is rectangular in shape. The anode 1950 receives the beamlets emitted from the cathodes 1930,1932 accelerates, focuses, and directs them along predetermined axes. The anode 1950 can also serve as a pole piece for a magnetic field that surrounds a VED (not shown) that is coupled to the electron gun 1900.

The electron gun 1900 varies from the electron guns 100 and 1300 discussed herein in that the gun utilizes only a single anode as opposed to two anodes to accomplish the suitable modification of the beamlets prior to their emission into a vacuum electron device. In one example, this single anode electron gun 1900 is suitable for operation of a vacuum electron device at relatively low current. In this manner, current can be obtained from a smaller cathode surface such that the cathode can be placed near to the predetermined axes. Accordingly, it is not necessary to translate the beamlets over a large radial distance, thereby allowing double convergence to be accomplished via the single anode 1950. The shell 1910 is employed to interface with the focus electrode 1920 and the anode 1950 to steer the beamlets emitted from the cathodes 1930, 1932. The size and strength of the field created can be dependent on the size, relative location and potential of the shell 1910, the focus electrode 1920 and the anode 1950 among other factors. If made out of an appropriate material, the shell 1910 could also minimize interference with outside magnetic activity.

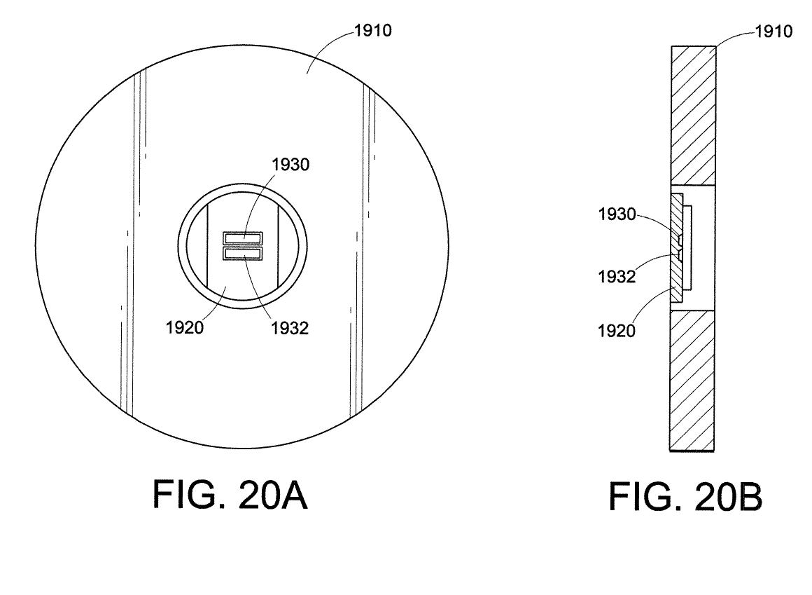

FIG. 20 shows the shell 1910 that surrounds the focus electrode 1920 and the cathodes 1930 and 1932 disposed therein in both a front view in 20A and a cross sectional side view in 20B. The outer shell 1910 can be at the same potential as the cathodes 1930, 1932 and further may encircle the cathodes 1930, 1932 to shape the fields between the anode 1950 and the cathodes 1930, 1932. The shell 1910 can extend beyond the plane of the cathodes 1930, 1932, as illustrated in FIG. 20B, to optimize optics of the beamlets emitted from the cathodes 1930,1932.

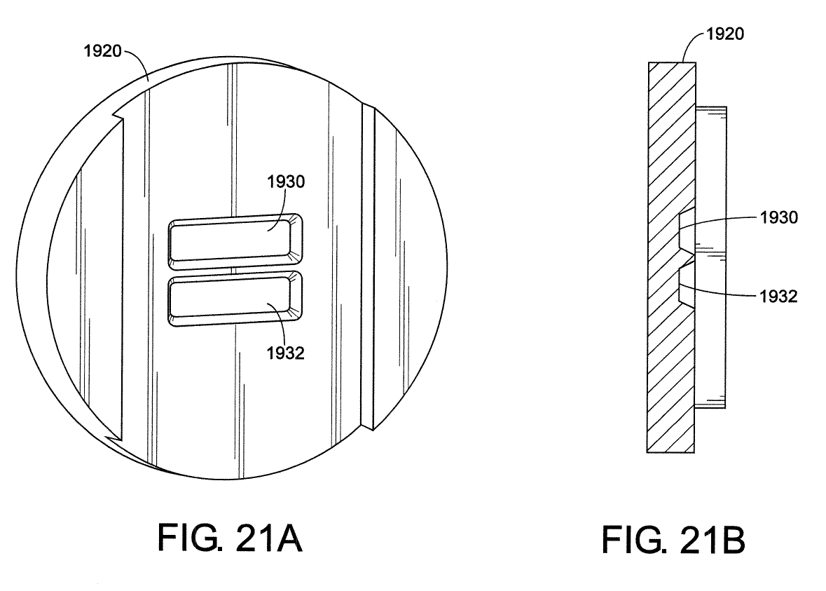

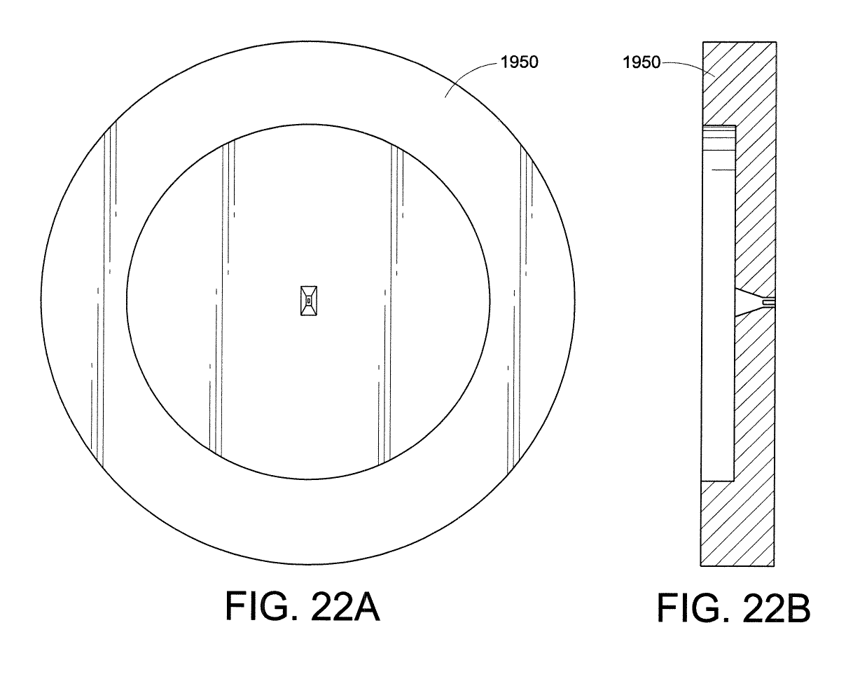

FIGS. 21A and 21B provide a detailed view of the focus electrode 1920 and the cathodes 1930, 1932 disposed therein. FIG. 21A shows a front isometric view of the cathode focus electrode. FIG. 21B shows a cross sectional view through an emissive area from the top of the focus electrode. In one embodiment, the size of the emitting faces of the cathodes 1930 and 1932 can be approximately 100 by 400 micron rectangles with rounded corners, wherein the radius of curvature is 20-30 microns. FIG. 22A illustrates a front view and FIG. 22B illustrates a cross sectional side view of the anode 1950. As utilized with the gun 1900, the anode 1950 can also serve as the first pole piece of a confining magnetic field utilized to shape and direct the beamlets through the vacuum electron device, as described with relation to the electron guns 100 and 1300 described herein.

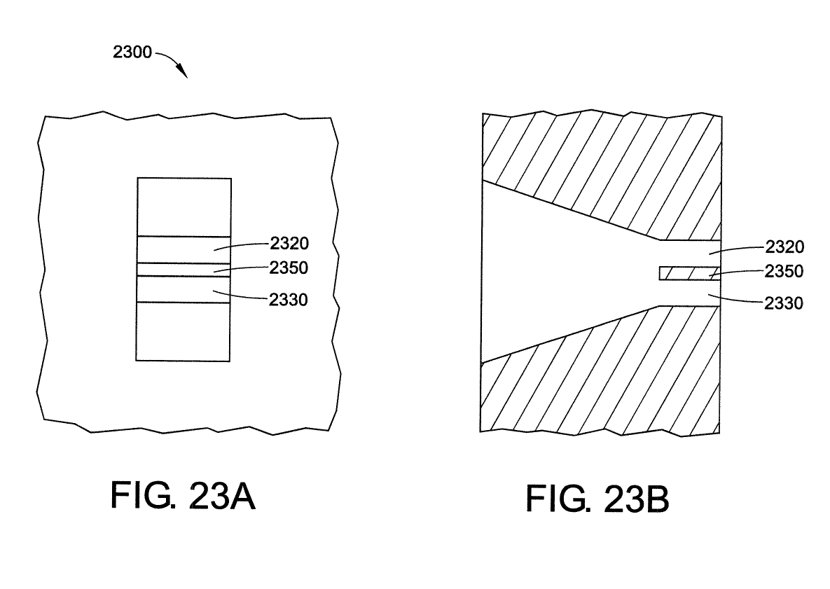

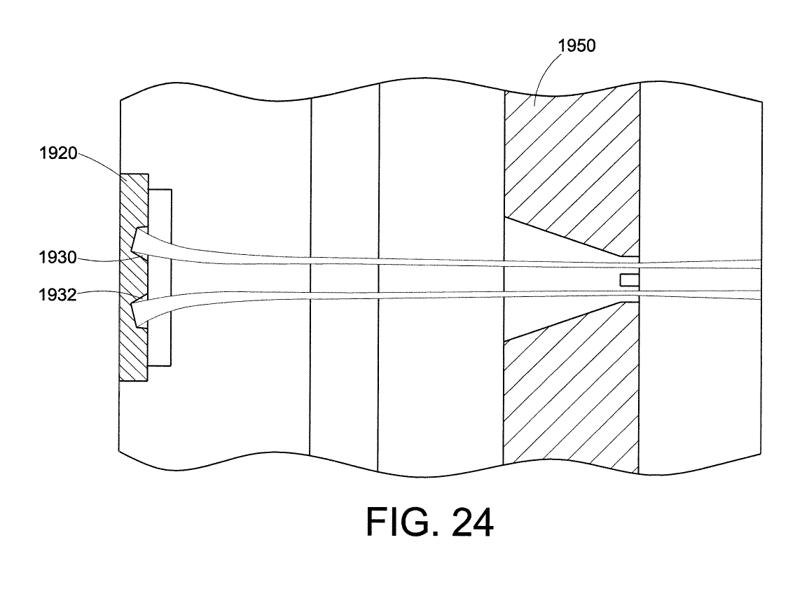

FIGS. 23A and 23B illustrate a front view and a sectional side view, respectively, of a detail of an aperture in the anode 1950. The aperture is comprised of a first opening 2320 and a second opening 2330 that are substantially similar in size and located in a stacked arrangement with a separation element 2350 located therebetween. The aperture 2300 receives beamlets from the cathodes 1930,1932 in a pyramidal shape and redirects them along a parallel path therefrom. FIG. 24 illustrates the path of the beamlets from the cathode through the gap and to the anode 1950. In one example, the potential of the beamlets upon emission from the cathodes 1930, 1932 is 0 V and increases to a voltage of approximately 6 kV commensurate with the potential of each element. In one example, the cathodes 1930, 1932 are at 0 V potential and the anode is at a 6 kV potential. Accordingly, the path and potential of the beamlets is substantially similar to that achieved by the dual anode gun 1300 discussed above.

It is to be appreciated that each of the embodiments 100, 1300 and 1900 of the electron gun can achieve a high current beam based on the convergence of a plurality of beamlets that can be directed down a predetermined axes within a vacuum electron device. The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. An electron gun, comprising:
a focus electrode that surrounds two or more cathodes, wherein each cathode emits a beamlet comprised of a plurality of electrons directed to a predetermined location;
a first anode that receives each beamlet at the predetermined location, accelerates each beamlet and changes the radius of each beamlet;
a second anode that receives each beamlet from the first anode, directs each beamiet along a predetermined axis and further accelerates each beamlet.

2. An electron gun as set forth in claim 1, wherein the cathodes are arranged in a pattern compatible with the operation of the VED.

3. An electron gun as set forth in claim 1, wherein each cathode is disposed at an angle that is compatible with the operation of the VED.

4. An electron gun as set forth in claim 1, wherein the beamlets are grouped into two clusters.

5. An electron gun as set forth in claim 4, wherein each cluster is equally spaced from the central axis of a vacuum electron device.

6. An electron gun as set forth in claim 1, wherein the first anode contains a first aperture and a second aperture, the first aperture and the second aperture correlate to a first cluster and a second cluster of cathodes.

7. An electron gun as set forth in claim 1, wherein the first anode contains an aperture for each beamlet.

8. An electron gun as set forth in claim 1, wherein the second anode contains a first opening and a second opening that are disposed axisymmetrically around the center point of the second anode.

9. An electron gun as set forth in claim 1, wherein the second anode contains a single aperture opening.

10. An electron gun as set forth in claim 1, the second anode further changes the radius of each beamlet received from the first anode.

11. An electron gun, comprising:
two or more cathodes that each emit a beamlet, and the beamlets are divided into multiple clusters;
a first anode that receives the clusters of beamlets via compatible openings, and accelerates each beamlet and reduces the radius of each beamlet;
a second anode that receives the beamlets from the first anode, directs each beamlet along a predetermined axis, further accelerates each beamlet and further compresses each beamlet.

12. An electron gun as set forth in claim 11, further including:
an electric field that is created between the first anode and the second anode to direct each beamlet along a predetermined axis.

13. An electron gun as set forth in claim 11, further including:
a focus electrode that surrounds each cathode in a suitable orientation for convergence of each of the clusters of beamlets.

14. An electron gun as set forth in claim 11, wherein the first cluster and the second cluster are located above and below a major axis respectively.

15. An electron gun as set forth in claim 11, the second anode further changes the radius of each beamlet received from the first anode.

16. An electron gun, comprising:
at least two cathodes that each emit a beamlet toward a predetermined location; and,
an anode that receives the beamlets emitted by the cathode, accelerates each beamlet, reduces the radius of each beamlet and directs each beamlet along a predetermined axis.

17. An electron gun as set forth in claim 16, wherein the anode is a first magnetic pole piece.

18. An electron gun as set forth in claim 16, further including:
a shell;
a focus electrode disposed within the shell, the focus electrode surrounds the two or more cathodes in an orientation and location suitable to emit beamlets to the anode.

19. An electron gun as set forth in claim 18, further including:
an electric field that is created via at least one of a potential, a size and a location of the shell, the focus electrode and the anode to direct each beamlet along a predetermined axis.

20. An electron gun as set forth in claim 16, wherein the focus electrode has a cross sectional thickness that is about half the cross sectional thickness of the shell, the focus electrode is disposed in a central location within the shell.
